(19) United States
(12) Patent Application Publication
(10) Pub. No.: US 2014/0297389 A1
(43) Pub. Date: Oct. 2, 2014

(54) Loyalty points card

(71) Applicants: Lyudmyla Nikolaevna Brown, Huntington, WV (US); Margaryta Lvovna Seliverstova, Huntington, WV (US)

(72) Inventors: Lyudmyla Nikolaevna Brown, Huntington, WV (US); Margaryta Lvovna Seliverstova, Huntington, WV (US)

(21) Appl. No.: 13/694,657

(22) Filed: Mar. 27, 2013

(51) Int. Cl. G06Q 30/02

(52) U.S. Cl. CPC G06Q 30/0231
USPC 705/14.31

(57) ABSTRACT

The goal of this proposal is to increase the income and profit of companies, by offering a company brand “Loyalty points card” that represents a new point system of purchasing goods. By rewarding customers with loyalty points, companies will develop brand loyalty in participating customers. Also, this system will give customers the opportunity to create sale days of their choice and consequently help save money on purchasing new items by surrendering used items in exchange for loyalty points that are equivalence rate to dollar value in a specific store, brand, or company.

### BACKGROUND OF INVENTION

Companies are always looking for ways to keeps customer loyalty to a brand, company or store as well as attracting new customers. Customers are usually attracted by quality of offered items, customer service, and special events such as sales days, special coupons or discounts, and clearance events on unpopular items. The uniqueness of this idea is that every customer will be in control of when to use a discount and the price that the customer is willing to pay for a desired item.

The prices on new items and quantity of used goods, kept at home by the customers, keep customers from buying new items from a store, company, or brand. A lack of desire to discard or surrender used items without any monetary recovery makes customers keep used and unused items at home. Companies, brands and stores can increase customer shopping activity by offering rewards for surrendering used items of the specific store, company, or brand to the store, company, or brand in exchange for loyalty points. Those loyalty points can be used to reduce the purchasing price of new goods. By offering this system, the store, brand or company will stimulate customer activity and, as a result, increase profit of the store, brand or company. Customers will feel rewarded for purchasing items from the store, brand or company.

### SUMMARY OF INVENTION

The present invention is based on increasing customer purchase activity by offering customers the “Loyalty points card” system. Customers will acquire points by surrendering to the store their unwanted or used items of the specific store, company, or brand. The points will be placed on the “Loyalty points card”. Customers will have a choice either to spend them immediately in-store or accumulated the points to a specific amount for future purchases. This system will give customers the opportunity to be in control of when to have sale days and how much money they want to spend.

It is important that every item has a permanently attached identification number (ID). By scanning item ID, the employee and/or customer will identify the monetary value of new items or the point value of surrendering the used item to the store, brand or company. The points value of the item will be calculated based on the original price of the surrendered item.

For customers' convenience, the loyalty points can be placed on a “Loyalty points card” itself, or a “Loyalty points card” that may be combined with a store gift card and/or a store credit card. It will increase credit card accounts for the store and allow customers to purchase more items with a credit card.

This system will decrease or eliminate the need for sales, clearance, or any other discount offers that might compete with the reward point system. The store will suffer little to no monetary lose, since item prices can be raised to counteract the reward system, allowing for the same profit rate, while building brand loyalty, improving public image, and increase profit and income of company.

### BRIEF DESCRIPTION OF THE DRAWINGS

FIG. 1 shows front view of the “Loyalty points card”.

FIG. 2 shows back view of the “Loyalty points card”.

FIG. 3 shows way of attaching identification number (ID) to soft surface of the item, for example from inside of the cloth.

FIG. 4 shows way of displaying item's identification number on hard surface, for example on the backside of the watch.

FIG. 5 shows information that will appear on the screen of the computer after scanning or entering item's identification number. That will help identify the correct item and calculate value points of surrendering the item to the store, company or brand. Also, some additional information on exchanging items for store points will be displayed on the screen of the computer.

### DETAILED DESCRIPTION OF THE “LOYALTY POINTS CARD”

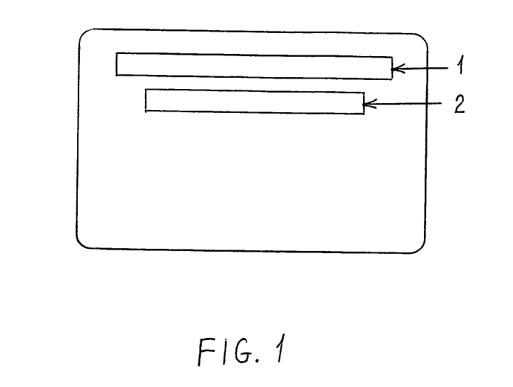

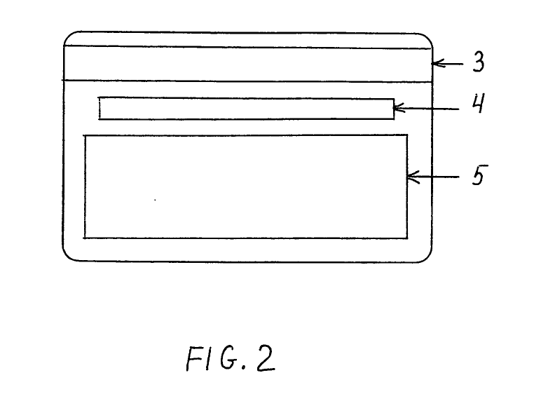

If a customer has an item(s) of a specific store, brand, or company, purchased no earlier than two “seasons” ago or one year, the customer can bring the item back to the store of the same brand. The store buys back the item for a fraction of the original price, no greater than 10%. An example of these items includes clothing; accessories, such as wallets, purses, luggage, gloves, and belts; watches and jewelry of silver, gold or platinum, with or without semiprecious or precious stones; home goods including any type of furniture, rugs, fine china and crystals. The store will only accept items that are in good condition, without any damage or alterations; some signs of wear are acceptable. The customer will then surrender the item(s) in exchange for points, as established and calculated by the store. These points will then be deposited on the “Loyalty points card”. For customers' convenience, the size of this card could be the same as any debit or credit card (See FIGS. 1 and 2).

The points are assigned a monetary value, valid only in the store brand where items were returned, on the same brand purchases, as assigned by the store. The points are dispersed on one of the types of the “Loyalty points card” for the store, and accumulate as more points are added, much like a debit card. The earned points can be used immediately for an in-store purchase, or accumulated for a future in-store purchase. The card will only be valid for the brand store where the items were returned, on the same brand purchases. The customer can use it immediately or within a time period, before the points expire.

The card can be issued as a “Loyalty points card” itself, “Loyalty points card” in combination with store gift card or it may be combined with a store credit card, in order to increase credit card accounts for the store and allow customers to purchase more items with credit. FIG. 1a shows front view of the “Loyalty points card”. Front side of the card will display store, company or brand name 1. Below that a card will display words “Loyalty points card” 2 that will mean that the card contains some amount of loyalty points. FIG. 2 shows the back of the “Loyalty points card”. Below the black magnet line 3, which is beside top margin of the card, will be the location of the loyal customer card number 4. Below card number will be area 5 that designates basic information on the store, brand or company's card and loyal customer purchasing reward system.

The points on the card can be used to decrease the purchasing price of the newest or current store items, before tax, through an equivalency rate of point to dollar value, as established by the store. The customer may choose how many points are used during a purchase. Points cannot be split, so, therefore, if more points are used than the purchasing price, the fraction of the point value left over after the purchase will not be returned to the customer, nor can it be used for tax; the store will take the fraction of the point value that is left over. Points cannot be transferred from one reward cardholder to another. Points cannot be used toward previous purchases, or for payments on a credit card. Points do not have any value outside of the store. The store has the right to seize points or rewards cards, as the points and cards are company property.

The store can recycle, resell, or donate the purchased-back items. This would allow the company to have tax breaks and a good environmental reputation among the public.

The customer will exchange old items of clothing for points that can be used as a discount on new items of clothing in the store. In order to accumulate more points, the customer will have to bring back more items of the same brand. By bringing back more items in exchange for reward points, the customer will be feel like he or she is getting rid of old clothing that is no longer is season, and getting money for it in return. The “Loyalty points card” system is very encouraging to the customer, since he or she will feel like they are saving money by turning in old clothing for new clothing.

In order to replace the amount of old clothing exchanged, the customer will purchase new clothing goods. The customer will feel prompted to purchase new goods by using the discount, given through the “Loyalty points card”, for the new items. As more items are returned, the customer will have less and less clothing remaining after every season, meaning they will need to buy more in order to replenish his or her wardrobe. Since it takes more returned old clothes to equal a new clothing purchase (a recommended ratio of 10:1 of similar items), the customer will need to invest more money into the store in order to keep the same amount of clothing going season after season.

This system also builds brand loyalty, since the customer can only purchase items with the discount of returned items of the same store, company or brand. The customer will also be more likely to purchase items with the discount than items of another brand/store of the same value. The store can also avoid loss since the items returned and purchased are of the same store, company or brand, since the point system directly correlates with the average purchasing price of a store, brand or company, as seen in the return/purchase value ratio established for similar items, as mentioned earlier.

It is likewise recommended that stores do not allow reward card that were opened in one country to be used in another; points cannot be accessed internationally. Every country will have unique accounts for reward points.

### DETAILED DESCRIPTION OF THE ITEMS IDENTIFICATION NUMBER

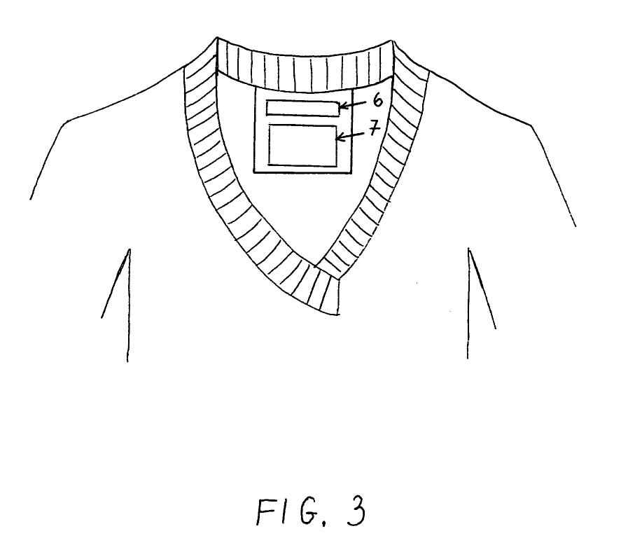

It is recommended that the store keep track of all brand items that it carries by placing or attaching an identification number on them. For soft surface items, such as clothes, tags with identification numbed may be sewn into them on an inside to prevent the identification number from possible wear, damage, or loss (See FIG. 3). Average item tag will display an identification number of the item 6 and other specific to item information 7, such as size; store, brand or company; material used for manufacturing; and/or place of manufactured item.

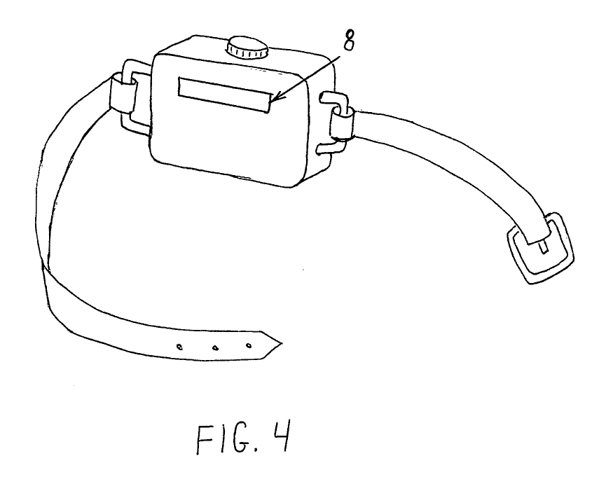

FIG. 4 shows example of placement of identification number on item with a hard surface. Identification number may be placed on hidden area or back of the item 8 in order to prevent that number from possible wear, damage, or loss.

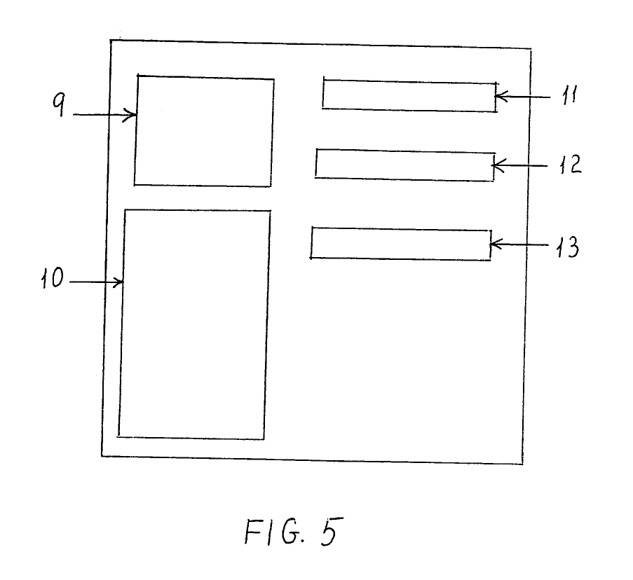

FIG. 5 shows information that will appear on the screen of the computer after scanning or entering identification number of the item. That information will include a description or image of the item 9, identification number of item 11, original price 12, and awarded points for specific item 13. Also, screen of the computer will displays additional information 10 on rules, conditions and time frame when item will be accepted in exchange for points.

If the tag or number is removed or appears suspicious or tampered, the store has the right to decline the return, not give the customer any points, and/or to end all transactions with the customer at the time.

1. Customers surrender their used items, such as clothing, accessories, wallets, purses, luggage, gloves, belts, furniture, rugs, fine china, crystals, watches and jewelry of silver, gold or platinum, with or without semiprecious or precious stones, to the brand, store, or company in exchange for store loyalty points.

2. The brand, store, or company buys back the items for a fraction of the original price, no greater than 10%, and pays the customers with loyalty points of claim 1.

3. The company puts those loyalty points of claim 1 on the customer's “Loyalty points card”.

4. Company can create three types of “Loyalty points cards” of claim 3, such as the “Loyalty points card” itself, “Loyalty points card” combined with a company gift card, and “Loyalty points card” combined with a store credit card.

5. The physical size of any “Loyalty points cards” of claim 4 can be the same as any regular debit or credit card.

6. The customer can use those loyalty points of claim 1 immediately in-store or accumulate them to a desirable amount for later use in-store, before the points expire.

7. The loyalty points of claim 1 have an equivalent dollar value only in the brand, store, or company where they were acquired, and therefore can be used only in that brand, store, or company.

8. The loyalty points of claim 1 cannot be split, transferred from one reward cardholder to another, used toward previous purchases, payments on a credit card, or taxes on purchase.

9. The customer will purchase new items with the loyalty points of claim 1, much like purchasing items with a discount, and if the loyalty points of claim are not enough to complete the purchase, the remaining amount of items' price will be covered with cash, store gift card, credit or debit cards by the customer.

10. The amount of loyalty points of claim 1 that are left on the “Loyalty points card” of claims 3 and 4 after the completion of the transaction will be automatically surrendered by the customer to the brand, store, or company.

11. Every item will have an Identification number that will help identify the item and calculate the loyalty points of claim 1 of the specific item that was surrendered by customer to the brand, store, or company.

12. After scanning or entering the identification number of the item of claim 9 on the computer, the store employee and/or customer will see the original price of the item, loyalty points of claim 1 that the customer will earn after surrendering that item to the brand, store, or company, a detailed description or picture of item, and store's polices and conditions on accepting items.

13. The identification number of claim 11 must be attached to the item permanently; soft surface items identification number of claim 11 will be displayed and permanently attached to the item from the inside tag, and on a hard surface identification number of claim 11 will be engraved or impressed on the back or a hidden side of the item.
